(19) United States
(12) Patent Application Publication
(10) Pub. No.: US 2007/0205724 A1
(43) Pub. Date: Sep. 6, 2007

(54) Advanced surface discharge lamp systems

(76) Inventors: Raymond B. Schaefer, Lexington, MA (US); John Gallagher, Goffstown, NH (US); Michael Grapperhaus, Dracut, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/367,770

(22) Filed: Mar. 3, 2006

(51) Int. Cl. H01J 17/04

(52) U.S. Cl. 313/633

(57) ABSTRACT

A high intensity surface discharge pulsed light source system includes a dielectric substrate, a first electrode near the dielectric substrate, a second electrode spaced from the first electrode and near the dielectric substrate, with containment for a discharge gas. The system is electrically powered and cooled from a single end. The discharge volume is sealed from the environment for long operational life, and the surface material chosen to allow for high intensity operation. Reflective coatings are employed to increase the light available for practical use. A pulsed electric discharge circuit provides practical operation for long and safe operation.

### GOVERNMENT SUPPORT

The invention was supported in part in an Advanced Technology Program under National Institute of Standards and Technology (NIST), Cooperative Agreement No. 70NANB1H3053. The Government has certain rights in the invention.

### BACKGROUND

Pulsed lamps are used in a wide variety of commercial, military, industrial, academic, medical and environmental applications, including treatment of contaminated water, industrial effluent and air, disinfection of water, juice and foods, air and other materials and objects, laser excitation, paint stripping, curing, photography, decontamination, strobes, beacons, and the like. In commercial flashlamps, stored electrical energy is deposited into a gas between two electrodes enclosed in a transparent envelope. The electrical discharge produces plasma that is a source of radiant energy with a spectrum that can range from the infrared, to the visible and ultraviolet regions of the spectrum. The envelope serves to confine the plasma generated by the electrical discharge. Electrical energy typically is delivered in a pulse to the flashlamp by a capacitor (or pulse-forming-network of inductors and capacitors) that has been charged up by a high voltage power supply. The flashlamp is repetitively pulsed to provide throughput for commercial use. The optical pulses from the flashlamp characteristically have a high peak power in a system with a relatively low average power.

The intensity from flashlamps is limited by its envelope, which explodes if the pressure and impulse from the pulsed electrical discharge are too large. Also, the lifetime of flashlamps depends strongly on its operating level relative to its explosion limit. In many uses it would be advantageous to operate at intensities that are impractical with flashlamps. Also, linear flashlamps have electrical connections at both ends of the envelope, and thus inherently have two ends. For some uses it would be advantageous if both electrical connections were made at one end. Furthermore, high average power flashlamps are cooled by flowing coolant along the outside of the lamp envelope, in one end and out the other, enclosed within a water jacket. This reduces the light available, especially in the V, and the set-up inherently has two ends.

The Surface Discharge (SD) lamp is a pulsed lamp that is known in the art and has many of the same generic characteristics described above for flashlamps while circumventing several limitations of flashlamps. In an SD lamp the pulsed electrical discharge is along the surface of a dielectric. Two such known inventions are found in Dr. Schaefer's U.S. Pat. Nos. 5,945,790, and 6,724,134, which patents are hereby incorporated herein by reference.

In many applications, SD lamps generate very high intensity light pulses. This is feasible because the light emitting plasma is generated along the surface of the dielectric, so that an envelope is not required to confine the plasma. The pressure generated by the high intensity discharge plasma is unconfined, and decreases as the plasma expands away from the dielectric. A second dielectric or window (e.g., an outer tube or “envelope” used with a tubular dielectric) is located away from the discharge, so that when the pressure pulse reaches the wall it has decreased below levels of concern for degradation. For cylindrical geometries, this implementation is found in applications in which the lamp is immersed in a medium, as in ultraviolet (UV) water treatment, as well as applications in which the lamp is placed in a reflector, such as for stripping paint.

### SUMMARY

In Dr. Schaefer's previous patents the SD lamp is cooled by flowing water interior to the substrate tube, in one end and out the other, thereby providing a means to cool the SD lamp from the inside.

Furthermore, SD lamps known-in-the-art employ seals (such as between the dielectric substrate and the electrodes) that utilize materials such as those commonly used for o-rings, which degrade over time, limiting practical lamp life. Methods known-in-the-art for sealing existing lamps such as flashlamps are not adequate for all the seals in SD lamps.

Also, for certain combinations of high intensity and pulse length, material is evaporated from the dielectric, thereby limiting the useful lifetime of the lamp.

Furthermore, a portion of the light leaving the plasma and impinging on the dielectric substrate is transmitted through the substrate and absorbed by the center conductor. In addition, SD lamps known-in-the-art operate with a wide range of geometrical configurations for a wide range of applications. Many employ electrical discharges on long dielectric surfaces.

In some SD lamps known-in-the-art the plasma generated along the dielectric is non-uniform, producing arc discharges along the dielectric. This may occur either initially or after operation for some time. In either case, the arcing is a precursor to end of useful lamp life.

In SD lamps known-in-the-art, the initiating electrode can be electrically positive or negative, and the ground electrode can be on either the feed or the opposite electrode.

Also, pulsed lamps known-in-the-art employ high voltage switches to deposit large energy pulses into the lamp. The high-energy pulse shortens the lifetime of common high voltage switches.

Accordingly, the present invention provides improvements to cooling and sealing of SD lamps. Another aspect relates to use of materials and electrical drivers to attain very high intensity SD lamps with long lifetime, uniform discharges, and practical electrical operation. Another aspect is directed to reflective coatings that increase the light output from the lamp. Yet another aspect relates to a geometrical improvement that allows operation at short discharge gaps. A further aspect relates to reducing switch requirements.

The present invention provides advantages for pulsed SD lamps and, in some cases, other pulsed lamp systems, which may be used separately or in conjunction, depending on the application.

According to one aspect of the present invention, a light emitting plasma is generated along the surface of the dielectric, so that an envelope is not needed for confining the plasma. The means for enclosing the gas may be located well away from the discharge, so that the SD lamp can operate at very high intensity.

Another aspect of the present invention provides means for cooling high average power SD lamps from one end, by defining regions inside the dielectric so that a coolant can flow both in and out of the same “feed” end. It is an additional feature of the SD lamp that the “opposite” end terminate, so that it can be mounted or otherwise implemented from the “feed” end. The present invention also provides a means for mechanically supporting the interior dielectric and electrode structure that contains the means for cooling.

Another aspect of the present invention provides for simultaneously achieving high intensity and long life operation through the use of specific dielectric materials for the substrate. Another aspect of the present invention provides a means for sealing the dielectric to the electrode and the electrode structure to the envelope. Additionally, embodiments of the invention may include a reflective coating to increase the quantity of light emitted from the lamp. In certain embodiments, an annular geometry may be employed to achieve a compact SD lamp with short electrode gap and small plasma.

Further aspects of the present invention provide a means for initiating the plasma discharge along the dielectric substrate that ensures the generation of a uniform plasma, a specific electrical polarity configuration for practical use, as well as a configuration for operating a lamp at high energy while minimizing stress on high voltage switches needed to operate the lamp.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a side view showing an embodiment of a closed end SD lamp in accordance with principles of the present invention.

FIG. 2 is a side view detail of the internal structure of the SD lamp of FIG. 1 at the feed end.

FIG. 3 is a side view of the opposite end of the SD lamp.

FIG. 4A illustrates an embodiment of an annular SD lamp.

FIG. 4B illustrates a sectional view of the embodiment of FIG. 4A taken along line A-A.

FIG. 5 is a circuit diagram of an embodiment of an electrical driver.

### DETAILED DESCRIPTION

In a surface discharge (SD) lamp, a plasma discharge is created by applying an electric potential that has sufficient magnitude to cause electronic breakdown of a discharge gas between two spaced apart electrodes near a dielectric surface. The resulting electronic discharge creates plasma streamers that emit intense incoherent light.

The present invention is directed to an SD lamp having electrical, cooling and support feed throughs and functions at one end of the lamp so that the entire structure of the lamp terminates at the other end of the lamp. This approach allows the SD lamp to be used when it is desirable for the lamp to be held at one end, or where the presence of electrical or cooling lines at both ends of the lamp is a complication. This approach may also be less expensive and more straightforward to implement. This allows the use of SD lamps, for instance, in water treatment applications where an array of UV lamps is attached at one end to an arm and in water.

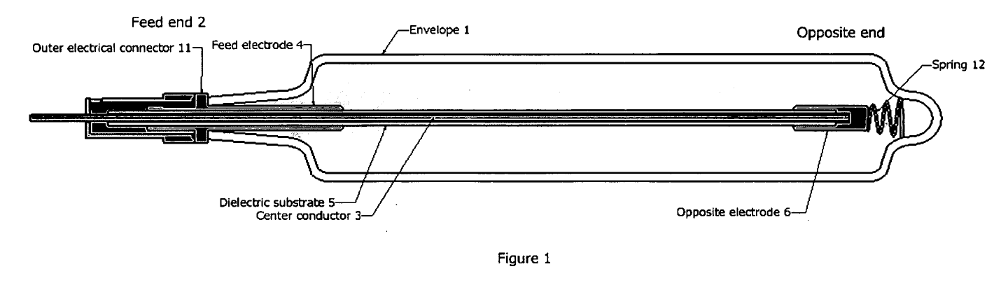

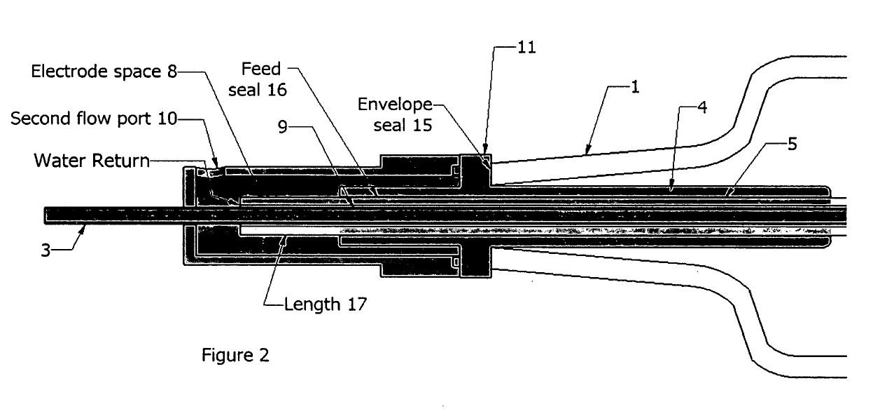

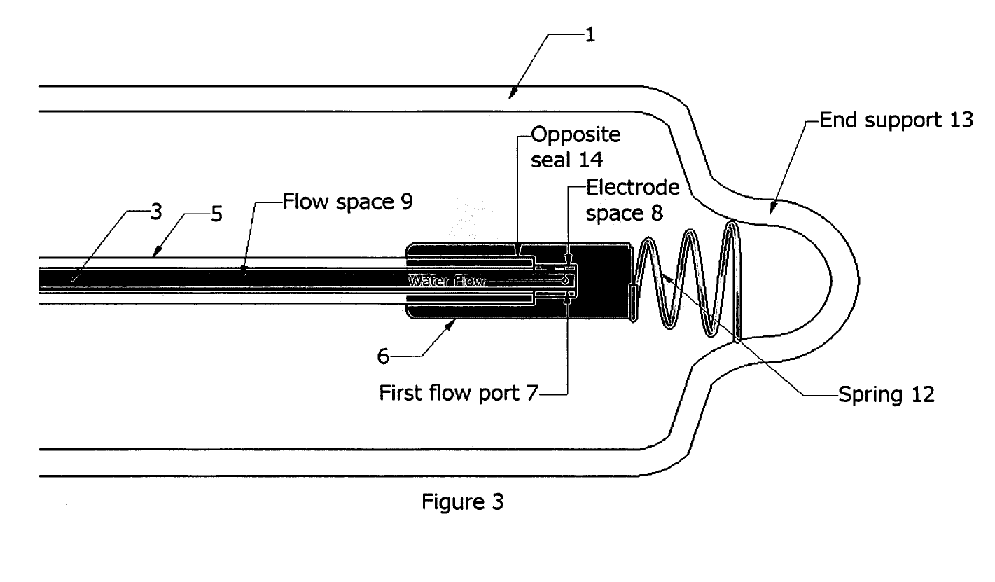

A variety of arrangements for configuring electrical and cooling functions at one end of the lamp are understood to be within the scope of the invention, but a particularly advantageous arrangement is illustrated in FIG. 1 and detailed in FIGS. 2 and 3. Both the electrical connections and coolant enter and leave the SD lamp envelope 1 at the feed end 2. An electric potential is applied between the center conductor 3 and feed electrode 4. During operation a plasma is generated along the dielectric substrate 5 between the feed electrode 4 and the opposite electrode 6, which is connected to the center conductor 3. The plasma completes the current path, so that the current both enters and leaves the lamp at the feed end 2. Furthermore, the center conductor 3 is a hollow tube and its outer diameter is smaller than the inner diameter of the dielectric substrate 5. Coolant flows into and out of the lamp by a path defined by the inside of the center conductor 3 and a flow space 9 between the outside of the center conductor 3 and the inside of the substrate 5. Many different specific means for directing the coolant can be employed, but an advantageous one is shown in FIGS. 2 and 3. In this arrangement the coolant flows along a path defined by the inside of the center conductor 3, a first flow port 7 in the center conductor at the opposite end, an electrode space 8B, a flow space 9 between the outside of the center conductor 3 and the inside of the substrate 5, another electrode space 8A at the feed end 2 and a second flow port 20.

The length of the dielectric substrate may be between one-half and double the length between the two electrodes.

According to another aspect of the invention, both electrical connections are made at the feed end 2 by means of the center electrical connector 10 and the outer electrical connector 11 which has feed electrode 4 extending therefrom.

Another feature of the invention provides for mechanically holding the opposite electrode 6 in place within the lamp. In one embodiment, with reference to FIGS. 1 and 3, a spring 12 is placed in contact with the end of the opposite electrode 6 to apply pressure to hold it in an end support 13, which may be a volume fabricated into the envelope and sized to accept the spring 12 and opposite electrode 6. Those skilled in the art should understand that other elastic means may be utilized to locate in place the unit comprising the electrodes, dielectric substrate and center conductor.

The gas environment inside the lamp needs to remain free of contaminants entering the lamp, and thus must be sealed from both the coolant inside the lamp as well as from the surrounding environment. Because of material mismatch, the dielectric substrate cannot be sealed directly to metal materials, such as the electrodes. Many types of O-rings can be employed, but may not provide sufficient seal at high vacuum or may degrade during lamp operation. Glass-to-metal seals known in the art are used, for instance, to seal the ends of flashlamps. However, such seals are typically located on the inside of a glass tube to seal a solid cylindrical conductor therein. With reference to FIG. 3, the SD lamp includes an opposite end seal 14 positioned on the outside of the substrate to seal the opposite electrode 6.

Furthermore, the SD lamp includes additional seals on the feed end 2 of the lamp to prevent leakage between the inside of the lamp and both the coolant inside the lamp and the environment outside the lamp. In an advantageous arrangement in FIG. 2, an envelope seal 15 seals the envelope 1 to the feed electrode 4, and a feed seal 16 seals the outside of the substrate 5 to the feed electrode 4. The seals employed in this embodiment may be accomplished using glass-to-metal solder and weld techniques known-in-the art. In addition, a length 17 of substrate between the feed electrode 4 and the center conductor 3 ensures that electronic discharges are generated between the feed 4 and opposite electrodes 6, and not between the end of the feed electrode 4 and the center electrical connector 10. In particular, the surface of the dielectric substrate may be soldered, welded, brazed or otherwise attached to the opposite electrode to provide a seal that isolates the discharge volume from the volume between the dielectric and the center conductor. Likewise, the surface of the dielectric substrate may be soldered, welded, brazed or otherwise attached to the feed electrode to provide a seal that isolates the discharge volume from the open volume inside the feed electrode. Using similar techniques, the feed electrode may be attached to the container or envelope to provide a seal that isolates the discharge volume from the region external to the lamp.

The plasma in the SD lamp generates electromagnetic radiation that is incident on the dielectric substrate 5. For sufficiently high light irradiance, the surface of the substrate may be caused to evaporate. This produces impurities in the gas and over time will degrade lamp operation. Materials such as plastics, standard glass, standard fused silica and quartz can produce impurities at plasma intensities of interest for some applications. In contrast, embodiments of the invention include materials such as sapphire, other materials based on Al₂O₃, UV transmissive quartz and fused silica, and other materials with high ablation thresholds, resistant to evaporation or other corrosive effects, to allow operation at high intensity without degrading the lamp.

Light is emitted from the plasma in all directions, so that some light impinges on the substrate 5 and is partially lost. To mitigate light losses, embodiments of the invention may include a coating of one or more material layers either on the inside or outside surface of the dielectric substrate 5 or the outside surface of the center conductor 3. The coating is reflective to electro-magnetic radiation. In one embodiment the coating may be aluminum with a protective overcoating of SiO₂. The thickness of the overcoating is preferably greater than 100, 500, 1000 or 2000 angstroms. In another embodiment, the coating may be a reflective dielectric material, such as Teflon or similar material with high diffusive reflectivity.

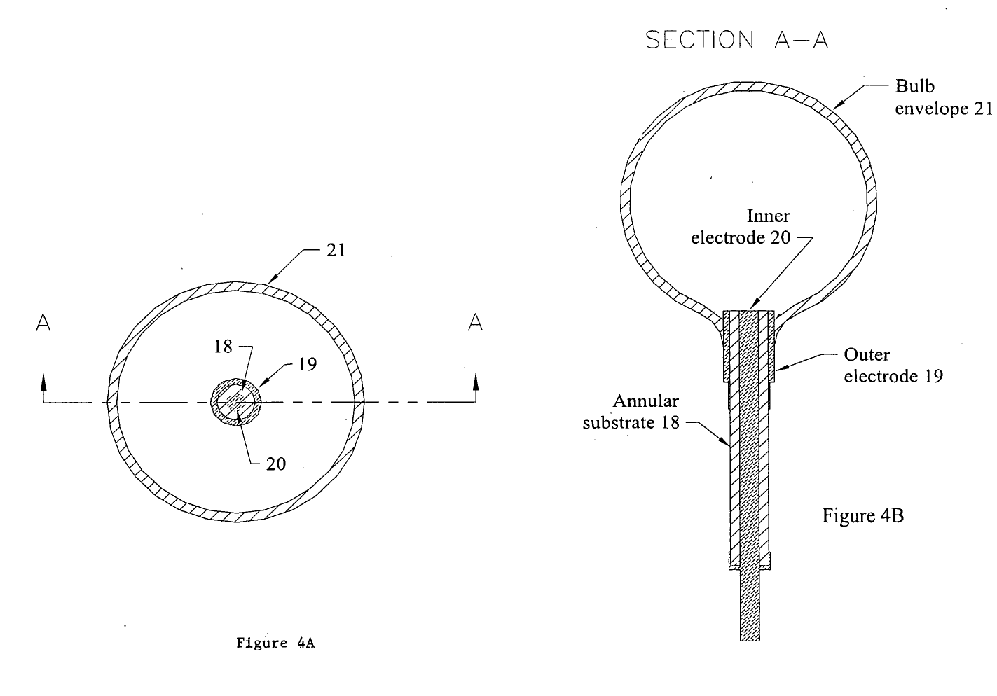

While FIG. 1 shows one preferred arrangement with the plasma generated along a tube, another preferred arrangement shown in FIGS. 4A and 4B employs an annular substrate 18 with an outer “ring” electrode 19 and an inner electrode 20 that may be a tube, ring or circle. FIGS. 4A and 4B show a bulb shaped envelope 21, but other shapes are to be understood as part of the invention. This arrangement can provide the means to generate both small and large plasmas with circular or annular shapes. This arrangement also may employ any one or all of the features of this invention already discussed.

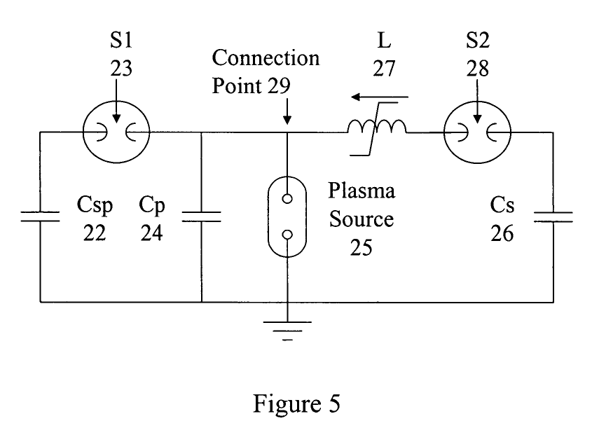

Proper operation of the SD lamp requires that the plasma be generated uniformly between the electrodes along the entire surface area of the dielectric substrate 5,18. According to another aspect of the present invention, an electrical circuit provides control for the required uniform plasma. Such a circuit for initiating and driving the plasma has general use in any instance in which plasma is generated between electrodes. With reference to FIG. 5, an embodiment of the electrical circuit has two discharge capacitors (or pulse-forming networks with capacitors and inductors, as is known in the art). An initiating loop has a capacitor Cₛₚ 22 that is charged to a relatively high voltage needed to electrically break down the gap between electrodes in the plasma source. A switch S₁ 23 allows Cₛₚ 22 to be charged up to the desired voltage and then triggered at a specified time. The initiator loop provides a voltage pulse with a peak of at least 5 kilovolts in some implementations but may be above 100 kilovolts in other implementations, with a fast rise time that may be as short as 0.010 microseconds and as long as 1.0 microseconds.

In some instances it may be advantageous to charge Cₛₚ 22 to a voltage that is below that needed for initiation. In such an instance, a peaking capacitor Cₚ 24 is attached in parallel to Cₛₚ 22 and the plasma source 25 (corresponding to the SD lamp or any other lamp), which is selected to increase the voltage across the electrodes by up to a factor of two.

A second, or driving, circuit loop has a capacitor Cₛ 26 with a capacitance much larger than Cₛₚ 22 that is charged to relatively low voltage and stores more energy than is stored in Cₛₚ 22. This loop also may have an inductor or saturable inductor 27 to control the pulse width and rise time of the electrical pulse from the Cₛ 26 loop. This loop also may have a separate switch S₂ 28 that allows Cₛ 26 to be charged up to the desired voltage and then triggered at a specified time. For optimal operation the switch S₁ 23 is triggered first and then, after a specified delay, S₂ 28 is triggered. In another preferred embodiment the switch S₂ 28 may be eliminated in instances in which the voltage on Cₛ 26 does not electrically break down the gap between the electrodes. In this instance the Cₛ 26 loop may have an inductor or saturable inductor 27 between Cₛ and the plasma source, as in FIG. 5, to enable the initiating circuit loop to serve its function. This embodiment eliminates the need for the second switch, S₂ 28, reducing the cost of the electrical driver. In another preferred embodiment, the Cₛ 26 loop is eliminated, and the increased voltage from Cₚ 24 serves to initiate the plasma uniformly.

The capacitance of the peaking capacitor is less than the capacitance of the initiator or sustainer loops, by a factor of at least three, or may be up to thirty or higher in certain applications.

The sustainer loop may operate at lower voltage and have higher energy than the initiator loop, with values depending on the application, but may operate as low as 0.5 kilovolts or as high as 50 kilovolts, with energies ranging from 1 joule to 20,000 joules.

In some embodiments, the sustainer loop may operate with a time delay relative to the initiator loop, with the delay ranging from 0.010 microseconds to 10.0 microseconds.

Another aspect of the invention provides an electrical charging arrangement that is safe and effective for use in practical lamp systems. In this instance, the high voltage side of the electrical driver (either positive or negative) is connected to the central electrical conductor 3. In reference to FIG. 5, the connection point 29 is connected to the center conductor 3 and grounded to the feed electrode 4. The charge on Cₛ 26 and Cₛₚ 22 can be either positive or negative, and one can be positive and the other negative. In a preferred embodiment using a saturable inductor, Cₛ 26 is charged positive or negative and Cₛₚ 22 has the opposite polarity.

While this invention has been particularly shown and described with references to preferred embodiments thereof, it will be understood by those skilled in the art that various changes in form and details may be made therein without departing from the scope of the invention encompassed by the appended claims.

What is claimed is:

1. A surface discharge lamp system comprising:
a container;
a dielectric substrate defining a surface supporting an electric discharge;
a feed electrode and an opposite electrode spaced from each other, the opposite electrode located within the container, both feed and opposite electrodes placed near the dielectric substrate surface, the electric discharge occurring along the surface of the dielectric substrate between proximate tips of the feed and opposite electrodes;
a center electrical conductor underneath or inside the dielectric substrate and connected to the opposite electrode;
the container enveloping the electrodes, dielectric substrate and center conductor to maintain a discharge environment with the feed electrode and center conductor configured for making connections external to the container.

2. The lamp system as defined in claim 1, wherein the container is shaped to locate in place the unit comprising the electrodes, dielectric substrate and center conductor.

3. The lamp system as defined in claim 1, wherein a spring or elastic means locates in place a unit comprising the electrodes, dielectric substrate and spring.

4. The lamp system as defined in claim 1, employing both a shaped container and spring or elastic means for locating in place the unit comprising the electrodes, dielectric substrate and spring.

5. The lamp system as defined in claim 1, where the dielectric substrate surface and container have an approximately cylindrical shape.

6. The lamp system as defined in claim 1, wherein the surface of the dielectric substrate is soldered, welded, brazed, or otherwise attached to the opposite electrode to provide a seal that isolates the discharge volume from the volume between the dielectric and the center conductor.

7. The lamp system as defined in claim 1 wherein the dielectric substrate is a tube and the opposite electrode is in the shape of a cup, fitting over the end of the substrate.

8. The lamp system as defined in claim 1, wherein the surface of the dielectric substrate is soldered, welded, brazed, or otherwise attached to the feed electrode to provide a seal that isolates the discharge volume from an open volume inside the feed electrode.

9. The lamp system as defined in claim 1, wherein the feed electrode is soldered, welded, brazed, or otherwise attached to the container or an envelope, to provide a seal that isolates the discharge volume from the region external to the lamp.

10. The lamp system as defined in claim 1, wherein the dielectric substrate is extended to provide a path length between the feed electrode and the center conductor to prevent an electrical discharge.

11. The lamp system as defined in claim 10, wherein the length of the dielectric substrate is between one-half and double the length between the two electrodes.

12. The lamp system as defined in claim 1 wherein the dielectric substrate is a tube and the feed electrode is in the approximate shape of a tube that slides over the substrate and is positioned to prevent an electrical discharge.

13. The lamp system as defined in claim 1, wherein the dielectric substrate is a material that resists evaporation or other erosive effects from high intensity plasma discharges.

14. The lamp system as defined in claim 13 in which the material is sapphire, other Al₂O₃ based material, or fused silica or quartz with high UV transmissivity.

15. The lamp system as defined in claim 1, in which at least the outside or inside surface of the dielectric substrate or the outside surface of the center conductor has a coating of one or more material layers that is reflective to electromagnetic radiation.

16. The lamp system as defined in claim 15, in which the coating comprises aluminum with a protective overcoating.

17. The lamp system as defined in claim 16 wherein the overcoating is SiO₂.

18. The lamp system as defined in claim 17 where the thickness of the overcoating is greater than 100, 500, 1000 or 2000 angstroms.

19. The lamp system as defined in claim 15, in which the coating comprises a reflective dielectric material.

20. The lamp system as defined in claim 19 where the coating is Teflon or similar material with high diffusive reflectivity.

21. The lamp system as defined in claim 1, wherein the feed and opposite electrodes are in a co-axial or annular arrangement and the dielectric substrate fills the annular gap between the electrodes.

22. The lamp system as defined in claim 21, where the dielectric substrate further comprises a hollow sleeve that defines a space for a liquid or gas to flow in or out of the lamp.

23. The lamp system as defined in claim 22, further comprising means for a liquid or gas to flow into or out of the space inside the center conductor.

24. The lamp system as defined in claim 1, wherein two pulsed power loops are employed to initiate and sustain the plasma.

25. The lamp system as defined in claim 24 wherein the initiator loop provides a voltage pulse with a peak of at least 5 kilovolts and may be above 100 kilovolts, with a rise time between 0.0010 microseconds and 1.0 microseconds.

26. The lamp system as defined in claim 24, wherein the sustainer loop operates at lower voltage and has higher energy than the initiator loop, operating between 0.5 kilovolts and 50 kilovolts, with energies between 1 joule and 20,000 joules.

27. The lamp system as defined in claim 24, in which the sustainer loop operates with a time delay relative to the initiator loop, where the time delay is between 0.010 microseconds and 10.0 microseconds.

28. The lamp system as defined in claim 24, further comprising a peaking capacitor connected in parallel to the two loops to provide increased voltage to the plasma source.

29. The lamp system as defined in claim 28, wherein the capacitance of the peaking capacitor is less than the capacitance of the initiator or sustainer circuit.

30. The lamp system as defined in claim 29, where the capacitance of the peaking capacitor is smaller than the smaller of the initiator and sustainer capacitance, by a factor of at least three.

31. The lamp system as defined in claim 24, further comprising two high voltage switches, one for the initiator loop and the other for the sustainer loop, to charge each loop.

32. The lamp system as defined in claim 31 wherein the two switches control the time delay by triggering each loop at the desired time.

33. The lamp system as defined in claim 24, in which the initiator loop has a high voltage switch for starting the discharge and a passive or saturable inductor in the sustainer loop to provide electrical isolation and control the time delay.

34. The lamp system as defined in claim 33 in which the initiator and sustainer loops have opposite charging polarities, with a passive saturable inductor to produce the required time delay.

35. The lamp system as defined in claim 1, in which the center conductor and opposite electrode are at high voltage, positive or negative, and the feed electrode is grounded.

36. The lamp system as defined in claim 1, in which the center conductor and opposite electrode are grounded, and the feed electrode is at high voltage, either positive or negative.

37. A surface discharge lamp system comprising:
a dielectric substrate defining a surface supporting an electric discharge;
a feed electrode and an opposite electrode spaced from each other, both feed and opposite electrodes placed near the dielectric substrate surface, the electric discharge occurring along the surface of the dielectric substrate between proximate tips of the feed and opposite electrodes;
a center electrical conductor underneath or inside the dielectric substrate and positioned with a space between its surface and the surface of the dielectric substrate, the center conductor having an internal open volume with openings at either end to allow liquid or gas to flow in at one location and out at another location, the center conductor arranged to allow a gas or liquid to flow outward into, or inward from, the space between the inside surface of the dielectric substrate and the outside surface of the center conductor, and means for the gas or liquid to exit or enter the space.

38. The lamp system as defined in claim 37, wherein the system is located within a container.

39. The lamp system as defined in claim 38, wherein the container is shaped to locate in place the unit comprising the electrodes, dielectric substrate and center conductor.

40. The lamp system as defined in claim 37, wherein a spring or elastic means locates in place a unit comprising the electrodes, dielectric substrate and spring.

41. The lamp system as defined in claim 37, employing both a shaped container and spring or elastic means for locating in place the unit comprising the electrodes, dielectric substrate and spring.

42. The lamp system as defined in claim 41, where the dielectric substrate surface and container have an approximately cylindrical shape.

43. The lamp system as defined in claim 37, wherein the surface of the dielectric substrate is soldered, welded, brazed, or otherwise attached to the opposite electrode to provide a seal that isolates the discharge volume from the volume between the dielectric and the center conductor.

44. The lamp system as defined in claim 37, wherein the dielectric substrate is a tube and the opposite electrode is in the shape of a cup, fitting over the end of the substrate.

45. The lamp system as defined in claim 37, wherein the surface of the dielectric substrate is soldered, welded, brazed, or otherwise attached to the feed electrode to provide a seal that isolates the discharge volume from an open volume inside the feed electrode.

46. The lamp system as defined in claim 37, wherein the feed electrode is soldered, welded, brazed, or otherwise attached to the container or an envelope, to provide a seal that isolates the discharge volume from the region external to the lamp.

47. The lamp system as defined in claim 37, wherein the dielectric substrate is extended to provide a path length between the feed electrode and the center conductor to prevent an electrical discharge.

48. The lamp system as defined in claim 47, wherein the length of the dielectric substrate is between one-half and double the length between the two electrodes.

49. The lamp system as defined in claim 37 wherein the dielectric substrate is a tube and the feed electrode is in the approximate shape of a tube that slides over the substrate and is positioned to prevent an electrical discharge.

50. The lamp system as defined in claim 37, wherein the dielectric substrate is a material that resists evaporation or other erosive effects from high intensity plasma discharges.

51. The lamp system as defined in claim 50 in which the material is sapphire, other Al₂O₃ based material, or fused silica or quartz with high UV transmissivity.

52. The lamp system as defined in claim 37, in which at least the outside or inside surface of the dielectric substrate or the outside surface of the center conductor has a coating of one or more material layers that is reflective to electromagnetic radiation.

53. The lamp system as defined in claim 52, in which the coating comprises aluminum with a protective overcoating.

54. The lamp system as defined in claim 53, wherein the overcoating is SiO₂.

55. The lamp system as defined in claim 54 where the thickness of the overcoating is greater than 100, 500, 1000 or 2000 angstroms.

56. The lamp system as defined in claim 52, in which the coating comprises a reflective dielectric material.

57. The lamp system as defined in claim 56 where the coating is Teflon or similar material with high diffusive reflectivity.

58. The lamp system as defined in claim 37, wherein the feed and opposite electrodes are in a co-axial or annular arrangement and the dielectric substrate fills the annular gap between the electrodes.

59. The lamp system as defined in claim 58, where the dielectric substrate further comprises a hollow sleeve that defines a space for a liquid or gas to flow in or out of the lamp.

60. The lamp system as defined in claim 37, wherein two pulsed power loops are employed to initiate and sustain the plasma.

61. The lamp system as defined in claim 60, wherein the initiator loop provides a voltage pulse with a peak of at least 5 kilovolts and may be above 100 kilovolts, with a rise time between 0.0010 microseconds and 1.0 microseconds.

62. The lamp system as defined in claim 60, wherein the sustainer loop operates at lower voltage and has higher energy than the initiator loop, operating between 0.5 kilovolts and 50 kilovolts, with energies between 1 joule and 20,000 joules.

63. The lamp system as defined in claim 60, in which the sustainer loop operates with a time delay relative to the initiator loop, where the time delay is between 0.010 microseconds and 10.0 microseconds.

64. The lamp system as defined in claim 60, further comprising a peaking capacitor connected in parallel to the two loops to provide increased voltage to the plasma source.

65. The lamp system as defined in claim 64, wherein the capacitance of the peaking capacitor is less than the capacitance of the initiator or sustainer circuit.

66. The lamp system as defined in claim 65, where the capacitance of the peaking capacitor is smaller than the smaller of the initiator and sustainer capacitance, by a factor of at least three.

67. The lamp system as defined in claim 60, further comprising two high voltage switches, one for the initiator loop and the other for the sustainer loop, to charge each loop.

68. The lamp system as defined in claim 67, wherein the two switches control the time delay by triggering each loop at the desired time.

69. The lamp system as defined in claim 60, in which the initiator loop has a high voltage switch for starting the discharge and a passive or saturable inductor in the sustainer loop to provide electrical isolation and control the time delay.

70. The lamp system as defined in claim 69 in which the initiator and sustainer loops have opposite charging polarities, with a passive saturable inductor to produce the required time delay.

71. The lamp system as defined in claim 37, in which the center conductor and opposite electrode are at high voltage, positive or negative, and the feed electrode is grounded.

72. The lamp system as defined in claim 37, in which the center conductor and opposite electrode are grounded, and the feed electrode is at high voltage, either positive or negative.
